(19) United States
(12) Patent Application Publication
(10) Pub. No.: US 2004/0099975 A1
(43) Pub. Date: May 27, 2004

(54) Method of preparing a surface modifier for nanoparticles, surface-modified inorganic oxide nanoparticles, and applications thereof

(75) Inventors: Ru-Yu Wu, Tao Yuan City (TW); Jeng-Gung Wang, Hsi Chu City (TW); Shiaw-Tseh Chiang, Chung Li City (TW)

Correspondence Address: FOLEY AND LARDNER, SUITE 500, 3000 K STREET NW, WASHINGTON, DC, 20007, US

(73) Assignee: Far Eastern Textile Ltd.

(21) Appl. No.: 10/397,384

(22) Filed: Mar. 27, 2003

(30) Foreign Application Priority Data
Nov. 22, 2002 (TW) 091134111

(51) Int. Cl. C07F 7/18

(52) U.S. Cl. 264/4.1; 556/414; 556/457; 556/413

(57) ABSTRACT

A method of preparing a surface modifier for nanoparticles, and a dispersion of inorganic oxide nanoparticles are provided. The surface modifier is formed by hydrolyzing 1 part by weight of an alkoxysilane compound with 1˜9 parts by weight of an alcohol/water solution, and the alkoxysilane compound is hydrolyzed to form a silanol. The weight ratio of alcohol to water is 60:40˜95:5. The alcohol/water solution can control the degree of forming of silanol, and thus prevents self-condensation of the silanol. The dispersion is formed by dispersing inorganic oxide nanoparticles in the aforesaid surface modifier, and can be used in the manufacture of inorganic-organic polymeric functional materials, especially anti-UV polyester products.

### CROSS-REFERENCE TO RELATED APPLICATION

This application claims priority of Taiwanese Application No.91134111, filed on Nov. 22, 2002.

### BACKGROUND OF THE INVENTION

1. Field of the Invention

The present invention relates to a method of preparing a surface modifier for nanoparticles, a dispersion of inorganic oxide nanoparticles, and application of the dispersion to the manufacture of inorganic-organic polymeric functional materials, more particularly to a surface modifier which can be added to inorganic oxide nanoparticles to modify surfaces of the nanoparticles and to prevent aggregation of the nanoparticles so as to produce a substantially non-aggregated dispersion of inorganic oxide nanoparticles. The dispersion can be used with organic polymers to produce various inorganic-organic polymeric functional materials.

2. Description of the Related Art

It is known in the art to incorporate inorganic material, such as inorganic oxide, into organic polymers so as to produce composites with enhanced performance. The inorganic-organic composites that are commonly used include anti-ultraviolet materials, far infrared ray materials, anti-static materials, anti-electromagnetic materials, toners for ink-jet printers, and anti-reflection and anti-glare photo-coatings.

Since inorganic materials are generally polar, whereas organic polymers are generally non-polar, when they are mixed together, phase-separation and aggregation of the inorganic materials occur due to the difference in polarity. In particular, since the nanoparticles (10⁻⁹ m) have relatively high surface energy, the degree of aggregation is aggravated. This results in a reduction in particle number due to the aggregation and non-uniform dispersion of the nanoparticles during the manufacture of nanoparticle composites, thereby adversely affecting the desired function. Moreover, the aggregation could block screens to interrupt the manufacturing process. In a conventional process for manufacturing nano-composite materials, inorganic nanoparticles are added in powdered form. The resulting dust pollutes the environment of the work place and is detrimental to the health of people in the work place. To overcome this problem, it was suggested heretofore that the nanoparticles be supplied in the form of a dispersion.

Since the inorganic oxide nanoparticles are polar, an ionic dispersing agent is typically used to help disperse the nanoparticles in an aqueous dispersing medium. The dispersing medium typically includes water and polymeric monomers or polymer-compatible solvents. The properties of the dispersing agent determine the dispersing stability of the nanoparticles in the resulting dispersion and among the polymers. Therefore, the use of a suitable dispersing method is very important in the manufacture of a nanoparticle composite material. A widely used dispersing method involves the provision of steric hindrance. For example, a dispersing agent is added to the nanoparticles so as to be adsorbed onto surfaces of the nanoparticles, thereby hindering coagulation of the nanoparticles with one another. Alternatively, the dispersing agent is allowed to react initially with the nanoparticles so as to form an organic molecular overcoat on each of the nanoparticles, thereby stably dispersing the nanoparticles in the dispersing medium.

U.S. Pat. No. 5,536,615 discloses the use of an ionic surfactant as a dispersing agent for forming a dispersion of nanoparticles. The ionic surfactant has a hydrophillic terminal which is attracted to the nanoparticles, and an oleophillic terminal which is distributed in the dispersing medium so as to uniformly disperse the nanoparticles in the dispersion. In the case there is an environmental variation, such as existence of an electric field, change in acidity, and removal of water during condensation polymerization reaction, the surfactant would be ineffective, resulting in coagulation of the nanoparticles, thus preventing uniform distribution of the nanoparticles in the polymer. R.O.C. Patent publication No. 409127 (which corresponds to WO9816193 or JP9208438) discloses the use of polysilicones as a dispersing agent, and a dispersing medium to prepare a dispersion of TiO₂ nanoparticles. The dispersion of TiO₂ nanoparticles can be used for producing sun-block cosmetics. However, since the bonding between the polysilicone dispersing agent and the nanoparticles involves only physical attraction, and since no chemical bonding is created between the polysilicone dispersing agent and the nanoparticles, the dispersing agent could become ineffective due to environmental variations.

U.S. Pat. No. 5,558,968 discloses a dendrimeric toner particle which includes a core particle and dendrimers around the core particle, and a toner dispersion containing the dendrimeric toner particles. However, the construction of dendrons around the core particle involves a high-cost and complicated process using dendrimeric chemistry.

U.S. Pat. No. 6,194,070B1 discloses the use of polysiloxane with an Si—H group as a surface treating agent for treating surface of barium sulfate. The Si—H group reacts with the —OH group on the surface of barium sulfate to form a covalent bond therebetween so as to improve the dispersibility of the barium sulfate product. U.S. Pat. No. 6,331,329B1 discloses a surface modifying method using of a hydridosiloxane-containing polymer for modifying a metal surface. The silicon atom of the hydridosiloxane compound forms a covalent bond with the oxygen atom of a hydroxyl group on the metal surface. However, since the siloxane polymers per se are non-polar and are hydrophobic, the contact between the siloxane polymers and the metal surface is not good enough.

U.S. Pat. No. 6,224,980B1 discloses the use of a silane coupling agent and/or a silicone compound to modify the surface of titanium oxide particles. The titanium oxide particles are limited to have a BET specific surface area of from 55 to 150 m²/g, and an anatase/rutile crystal structure with a ratio of anatase falling between 0.3 to 0.98.

U.S. Pat. No. 6,239,194B1 discloses the use of a hydrolyzable organosiloxane composition for treating the surface of an inorganic filler, such as TiO₂ particles. The organosiloxane contained in the organic siloxane composition is completely hydrolyzed to form silanol and reacts with the hydroxyl group on the surface of the filler. However, the silanol can be consumed via self-dehydration condensation reaction. The process should thus be controlled to prevent over-consumption of the silanol. Additional siloxane compound might have to be added to maintain the concentration of the siloxane at a certain level.

Among the existing dispersing agents used for modifying surfaces of nanoparticles, the ionic-type dispersing agent undergoes physical adsorption with the nanoparticles and thus cannot produce sufficient bonding forces. The dendrimeric-type dispersing agent involves a complicated and high-cost treating process. The polymeric-type dispersing agent cannot keep good and stable contact with surfaces of inorganic nanoparticles. Moreover, the hydrolyzable organosiloxane dispersing agent suffers from the problem that the silanol undergoes self-condensation to result in a decrease in the concentration of the silanol.

### SUMMARY OF THE INVENTION

The aforementioned drawbacks of the prior arts are solved by the present invention. The present invention contemplates using a surface modifier that contains a hydrophillic, low molecular weight alkoxysilane compound and an alcohol/water solution in place of the siloxane polymer used in the prior art. A typical hydrolysis reaction of an alkoxysilane is a reversible reaction represented by the following equation (A):

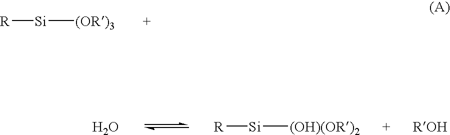

wherein, an increase in the concentration of R′OH can move the reaction to go leftward, thereby decreasing the degree of hydrolyzation of the alkoxysilane compound. By controlling the concentration of R′OH, the degree of hydrolyzation of the alkoxysilane can be adjusted to control the rate of forming silanol and to prevent self-condensation of a large amount of the silanol due to high concentration of the silanol. The addition of the alcohol/water solution in the present invention is based on this principle. When the surface modifier of the present invention is added to an inorganic oxide nanoparticle powder, the silanol formed by hydrolyzation of the alkoxysilane can keep good contact with the nanoparticles and undergoes a condensation dehydration reaction with the —OH groups on the surfaces of the nanoparticles. With the consumption of the silanol, the reaction represented by the equation (A) goes rightward and the alkoxysilane compound is hydrolyzed to form silanol, which then reacts and undergoes a condensation reaction with the —OH groups on the surfaces of the nanoparticles. In this manner, the silanol is supplied continuously from the alkoxysilane. The concentration of the silanol will not be excessive, and self-condensation of the silanol can be prevented due to the adjustment by the alcohol in the alcohol/water solution. A uniform protection layer on the surfaces of the inorganic nanoparticles results due to the condensation reaction of the silanol, as represented by the following equation:

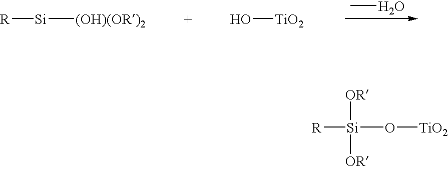

Since the attraction among the alkoxysilane molecules that are bonded to the nanoparticles is relatively weak, the nanoparticles will not coagulate and can be distributed uniformly in a dispersing medium so as to form a stable dispersion. When the dispersion is added to an organic polymer to prepare a functional organic composite, the dispersion can mix thoroughly with the organic polymer due to the weak affinity among the silane molecules of the protective layer and high compatibility thereof with the organic polymer. The problem of coagulation is obviated to prevent adverse effects on the properties of the resulting functional composite. The surface-modified inorganic nanoparticles according to the present invention can be widely applied to various kinds of inorganic-organic polymeric functional composites, especially to the manufacture of anti-UV polyester fibers.

According to a first aspect of the present invention, a method of preparing a surface modifier for nanoparticles, and the surface modifier produced by the method are provided. The method comprises the step of hydrolyzing 1 part by weight of an alkoxysilane compound with 1˜9 parts by weight of an aqueous solution containing alcohol/water at a ratio of 60:40˜95:5, thus resulting in a nanoparticles surface modifier. The alcohol/water solution in the hydrolyzation system has the function of adjusting the formation of the silanol, thus preventing an excess of the silanol, which could result in consumption of the silanol through a self-condensation reaction of the silanol per se. Therefore, the addition of the alkoxysilane compound for producing more amount of the silanol would be unnecessary. The method is thus cost effective.

According to a second aspect of the present invention, a dispersion of inorganic oxide nanoparticles substantially free of aggregation is provided, wherein 100 parts by weight of inorganic oxide nanoparticles are treated with 1˜100 parts by weight of the surface modifier prepared in the aforementioned method to form surface-modified inorganic oxide nonoparticles.

The dispersion of the inorganic oxide nanoparticles can be applied in the manufacture of an inorganic-organic polymeric functional material. According to a further aspect of the present invention, an inorganic-organic polymeric functional material, comprises 100 parts by weight of an organic polymer and 0.1˜95 parts by weight of surface-modified inorganic oxide nanoparticles, wherein the surface-modified inorganic oxide nanoparticles comprise 100 parts by weight of inorganic oxide nanoparticles, and 1˜100 parts by weight of a surface modifier added to the inorganic oxide nanoparticles to modify the surface of the nanoparticles, the surface modifier being prepared by hydrolyzing 1 part by weight of an alkoxysilane in the presence of 1-9 parts by weight of an alcohol/water solution.

The dispersion of the inorganic oxide nanoparticles may be added into a polymer during a polymerization process. For instance, the dispersion may be added into a polyester polymer to form an inorganic-organic polymeric functional material for producing an anti-UV polyester fiber composition. The inorganic-organic polymeric functional materials according to the present invention may also be used in producing far infrared ray materials, anti-static materials, anti-electromagnetic materials and anti-bacteria materials.

### BRIEF DESCRIPTION OF THE DRAWING

FIG. 1 is a graphical representation displaying UV transmittance of polyester fiber compositions prepared in the Examples and the Comparative Example.

### DETAILED DESCRIPTIONS OF THE PREFERRED EMBODIMENTS

The alkoxysilane compound used in the method of preparing a surface modifier according to the present invention is selected from the compounds represented by the following formulas (I)-(III):

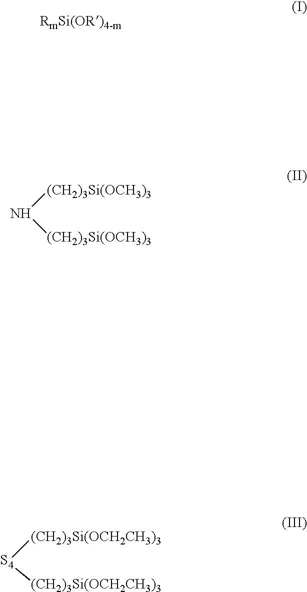

Each R is independenly selected from the group consisting of alkyl, γ-aminoalkyl, γ-(2,3-glycidoxy)alkyl, β-(3,4-epoxy)-cyclohexyl, γ-methacryloxy-alkyl, vinyl, vinylalkyl, γ-mercaptoalkyl, γ-isocyanato-alkyl, N-phenyl-γ-aminoalkyl, N-β-aminoalkyl-γ-aminoalkyl, and γ-ureidoalkyl. The alkyl contains 1˜10 carbon atoms. Each R′ is independently selected from C₁˜C₆ alkyl group. m is an integer of 1˜2.

Preferably, the alkoxysilane compound is selected from the compounds represented by the formula (I), where R is γ-(2,3-glycidoxyalkyl), and m is 1. In a preferred embodiment of the present invention, the alkoxysilane compound is γ-(2,3-glycidoxy)propyl-trimethoxysilane.

The alcohol used in the method of preparing the surface modifier according to the present invention is an alcohol soluble in water. Examples of suitable alcohol are methanol, ethanol, isopropanol, isobutanol and combinations thereof. In a preferred embodiment of the present invention, ethanol is used for adjusting the degree of hydrolyzation of the alkoxysilane compound. The amount of the alcohol/water solution is 3˜7 parts by weight based on 1 part by weight of the alkoxysilane compound. The weight ratio of alcohol/water is preferably 60:40˜95:5, and more preferably 70:30˜90:10.

Examples of the inorganic oxide nanoparticles suitable for use in the present invention are TiO₂, ZnO₂, ZrO₂, Fe₂O₃, NiO, Al₂O₃, SiO₂, Cr₂O₃, 3MgO.4SiO₂.H₂O, silicates, Al₂.O₃.SiO₂.XH₂O, FeOOH, etc., and combinations thereof. In a preferred embodiment of the present invention, the surface modifier is used to treat TiO₂ nanoparticles for preparing a substantially non-aggregated TiO₂ dispersion.

The amount of the surface modifier suitable in the present invention is 1˜100 parts by weight, preferably 1˜50 parts by weight based on 100 parts by weight of the inorganic oxide nanoparticles. At a reaction temperature of 40˜80° C., the rate of the reaction between the surfaces of the nanoparticles and the silanol is increased. A reaction temperature lower than 40° C. is not suitable for the surface reaction, while a reaction temperature higher than 80° C. would cause coagulation of the inorganic oxide nanoparticles.

The inorganic oxide nanoparticles, after being surface-modified by the surface modifier, can be dispersed in a dispersing medium to form a uniform and stable dispersion. Examples of suitable dispersing medium include water, monohydric alcohols, dihydric alcohols, and combinations thereof. In a preferred embodiment of the present invention, ethylene glycol is used as the dispersing medium for forming the dispersion. The amount of the dispersing medium is not particularly limited, and is adjustable in accordance with the conditions of use.

The dispersion of the inorganic oxide nanoparticles can be preserved for a long time, maintaining a stable dispersed state without phase-separation and coagulation.

Examples of organic polymers suitable for preparing an inorganic-organic polymeric functional material according to the present invention include polyester as described above, polyurethane (PU), polyamide, polyolefin, silicone, epoxy resin, rubber, phenolics, polycarbonate, melamine, polyether, polyvinyl alcohol (PVA), polymethyl methacrylate (PMMA), polystyrene (PS), acrylonitrile-butadiene-styrene (ABS) copolymer, polyvinyl chloride, and combinations thereof.

The amount of the surface-modified inorganic oxide nanoparticles used in preparing the inorganic-organic polymeric functional material is preferably in the range of 0.1 to 30 parts by weight based on 100 parts by weight of an organic polymer.

The dispersion of the present invention is particularly suitable for producing anti-UV polyester fiber. In one embodiment, a dispersion formed from the TiO₂ nanoparticles with a particle size of 50˜150 nm and added with a surface modifier and a suitable dispersing medium is used for preparing an anti-UV polyester fiber. The amount of the surface-modified inorganic oxide nanoparticles used in the manufacture of the polyester fiber is 0.1 to 30 parts by weight, preferably 0.3˜16 parts by weight, based on 100 parts by weight of polyester. Examples of the polyester suitable for producing the anti-UV polyester fiber are polyethylene terephthalate (PET), copolymers of polyethylene terephthalate (COPET), polytrimethylene terephthalate (PTT), polybutylene terephthalate (PBT), polylactic acid (PLA), aromatic polyesters, etc., and combinations thereof.

In a preferred embodiment of the present invention, PET is used for producing the anti-UV polyester fiber composition. The TiO₂ nanoparticles surface-modified in accordance with the present invention are added to PET during the polymerization of PET. With the surface modifier on the surfaces of the TiO₂ nanoparticles, the TiO₂ nanoparticles can be uniformly dispersed in the polymer melt when the polymer chain gradually grows during the polymerization reaction, until the final PET product is produced. After completion of the reaction, the polymer can be pelletized, precrystallized, and dried, and can then be spun to produce the UV-cut fiber. The resulting products include staples, filaments, textured yarns, etc. These fiber products can be knitted or woven via shuttle weaving or plain weaving, to form various fabrics which have excellent Ultraviolet Protection Factors. In addition to fibers and fabrics, the anti-UV PET products can be in other forms, such as films, sheets, and bottles, etc.

Moreover, in the process for producing the polyester fibers, non-nanosized TiO₂ particles with a larger particle size, such as in the scale of μm, and without surface modification may be added to serve as a dulling agent to make the polyester fiber more suitable for use.

The present invention will now be described in greater detail with reference to the following examples, which, however, are only illustrative and should not be interpreted to limit the scope of the present invention.

### EXAMPLES

Test Method and Standards for Physical Properties

The surface-modified inorganic oxide nanoparticles prepared in the following examples were evaluated according to the following methods:

(i) Stability: The surface-modified inorganic oxide nanoparticles were kept still and were observed to determine the time that takes for phase separation and precipitation of coarse particles to occur.

(ii) Particle Size Analysis: The surface-modified inorganic oxide nanoparticles were dispersed in a dispersing medium. The particle size of the inorganic oxide (TiO₂) was analyzed using the Dynamic Light Scattering (DLS), Zetasizer 3000 Model manufactured by Malvern Inc. Reliability of the results was determined by the reproductivity of K_{count} (light scattering intensity) and Zₐᵥₑ (average particle size). At least three values were taken on each sample. K_{count} should be within a range without dramatic change. K_{count} value in the range of 10˜500 is acceptable. K_{count} value in the range of 50˜200 is preferred. Noticeable change in the K_{count} value or the Zₐᵥₑ value indicates that the particles are coagulating or descending. In addition, Polydispersity Index (Poly. Index) can be determined by the DLS. Poly. Index in the range of 0˜0.03 indicates that the particles are monodisperse. Poly. Index in the range of 0.03˜0.08 indicates that the particles are nearly monodisperse. Poly. Index in the range of 0.08˜0.5 indicates that one or more than two particle size distributions exist. Poly. Index greater than 0.5 (very Polydisperse) indicates that the particles maybe are descending in the sample.

The physical properties of the inorganic-organic polymer functional material were determined by the following testing methods:

(iii) Ash content in the fiber: The content of inorganic material was determined (wt %). A suitable amount of fiber was dried and weighted, and was heated in a furnace (800° C.) for 4 hours in order to ashen the fiber. Thereafter, the fiber was moved out of the furnace and was weighted again. The ratio of the weight of fiber after ashing to the weight of fiber before ashing is defined as ash content in the fiber. Ash content is used to determine the loss of TiO₂ nanoparticles due to coagulation during the polymerization and spinning processes. For instance, in Example 1, the theoretical value of ash content=the amount of TiO₂=TiO₂ nanoparticles 5000 ppm+non-nano sized TiO₂ particles 4000 ppm=9000 ppm=0.9 wt %.

(iv) UV transmission: The polyester pellets were melted and blow-molded to form a bottle. The bottle was scanned using a DU-600 Model UV/VIS spectrometer to determine the UV transmittance (%) at UV spectrum (290˜400 nm).

(v) Screen pressure increasing rate during spinning: The polyester pellets were pre-crystallized, dried and then spun. At the spinneret orifice, the following seven metal screens were used and arranged in sequence: #900, #6400, #900, #9500, #900, #6400, #900. The temperature of the extruder was set at a temperature that is normally used for PET spinning. Screen pressure increasing rate of the seven metal screens was determined by a long-term mass-production spinning test. The increasing rate should not exceed 1 bar/hr for the material to satisfy commercial process standard requirements.

Source of the Chemicals

(a) Alkoxysilane compound, γ-(2,3-glycidoxy)propyl-trimethoxysilane: Available from CROMPTON S.A. OSI SPECIALITIES, under the tradename of Silquest®A-187Silane, purity: 98%

(b) Alcohol (ethanol): Industrial grade, purity: 95 vol %, density: 0.81 g/cm³.

(c) TiO₂ nanoparticles: TiO₂ suspension in ethylene glycol/water (dispersing medium), available from Sachtleben Chemie GmbH, under the tradename of Homobitec S-120G Suspension. Contents: TiO₂(20.0 wt %), ethylene glycol (43.1 wt %), water (35.9 wt %); potassium tripolyphosphate (1.0 wt %)

### Example 1

Preparation (1): Preparation of Nanoparticle Surface Modifier:

6 g of γ-(2,3-glycidoxy)propyltrimethoxysilane, 27 ml (about 21.879) of ethanol, and 3 ml (3 g) of water (1 part by weight of alkoxysilane compound and 4.14 parts by weight of an alcohol/water solution, weight ratio of alcohol/water=88:12) were added into a 100 ml beaker. The beaker was sealed with aluminum foil at the top, and was then heated on a hot plate at 60° C. for 30 minutes with stirring. The reaction mixture was allowed to cool off and was then collected in a capped bottle.

Preparation (2): Preparation of the Surface-Modified Inorganic Oxide Nanoparticles:

1 Kg of Hombitec S 120G Suspension was added into a 2 L glass bottle equipped with a temperature controller and a stirrer, and was stirred to disperse the nanoparticles uniformly in the dispersion medium. Simultaneously, the surface modifier prepared in the above Preparation (1) was slowly added into the bottle with stirring. The reaction mixture was heated. In order to ensure complete condensation dehydration reaction, the reaction continued for 4 hours after the internal temperature reached 55° C., and was then stopped. The resulting product was collected and filtered through the #9500 (about 67 μm) screen under vacuum to remove impurities and coagulated particles. Only a small amount of coagualated particles was found after surface modification of the TiO₂ nanoparticles. After filtering, surface-modified particles were collected. The content of TiO₂ was 32 wt % (measured after drying the solvent). The results of the stability test and the particle size analysis are listed in Table 1.

Preparation (3): Preparation of An Anti-UV Polyester Fiber

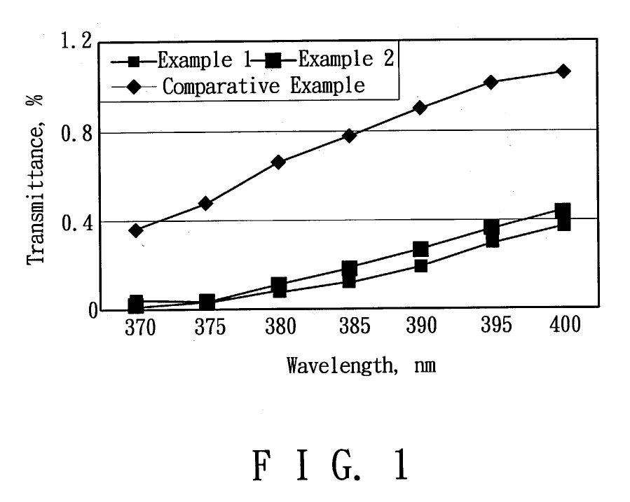

The surface-modified particles prepared in Preparation (2) were diluted using ethylene glycol to form a dispersion with a concentration of 10 wt %. Sb₂O₃ (300 ppm) and trimethyl phosphate (15 ppm) were added into a paste tank that contains terephthalic acid (34.6 Kg) and ethylene glycol (16.8 Kg). After esterification, the dispersion of the TiO₂ nanoparticles (10 wt %, 5000 ppm, particle size: ˜100 nm) was added into the polymerization tank. Then, the tank was added with non-nanosized TiO₂ particles (4000 ppm, particle size: 0.3 μm), which serve as a dulling agent. At the end of the polymerization, the polyester was pelletized to form PET pellets which have a Relative Viscosity of 1.65 and which are blended with substantially non-aggregated TiO₂ nanoparticles. The PET pellets were similarly melted and blow-molded to conduct a UV transmission test. The results are shown in FIG. 1.

The PET pellets were pre-crystallized, dried and then spun into fiber. The properties of the polyester fiber composition were evaluated using the above-described test methods for testing ash content in the fiber and the screen pressure increasing rate. The results are listed in Table 1.

### Example 2

(1) Preparation of nanoparticle surface modifier: same as in Example 1.

(2) Preparation of the surface-modified inorganic oxide nanoparticles: The same procedures were followed as in Example 1, except that the reaction temperature was 65° C. The content of TiO₂ was 32.8% TiO₂ after surface modification. The physical properties are listed in Table 1.

(3) Preparation of an anti-UV polyester fiber: The same procedures were followed as in Example 1, except that the amount of the TiO₂ nanoparticles was 4742 ppm. The physical properties are listed in Table 1.

Comparative Example

An anti-UV polyester fiber is prepared by following the procedures of Example 1, except that TiO₂ nanoparticles were not treated with the surface modifier of the present invention. The physical properties are listed in Table 1.

TABLE 1

| | | | | | Comparative | |
|---|---|---|---|---|---|---|
| | Physical properties | | Example 1 | Example 2 | Example | |
| Surface-modified | Stability | | More than | More than | 0.5 | day |
| TiO₂ | | | half a year | half a year | | |
| | Particle size | Concentration | 0.08 | — | 0.1 | |
| | analysis | (wt %) | | | | |
| | | K_{count} | 186.8 | — | 110 | |
| | | Zₐᵥₑ (nm) | 100.7 | — | 129.6 | |
| | | Poly. Index | 0.527 | — | 0.987 | |

| Polyester fiber | Ash content in | 0.89 | 0.86 | 0.67 |
|---|---|---|---|---|
| | the fiber (wt %) | (theoretical | (theoretical | (theoretical |
| | | value: 0.9) | value: 0.87) | value: 0.9) |
| | Screen pressure | 0.7 | 1.0 | 3.0 |
| | increasing rate | | | |
| | (bar/hr.) | | | |

Results:

As shown in Table 1, the surface-modified TiO₂ nanoparticles according to the present invention can be kept stable for a long period of more than half a year, which is longer than that of the Comparative Example. The average particle size of the dispersion used in the present invention is relatively small (only about 100 nm). This indicates that there is substantially no aggregation in the dispersion. The Poly. Index value measured in the Comparative Example is 0.987, which is much greater than that in Example 1, indicating that particle coagulation is serious in the Comparative Example. In both Examples 1 and 2, the ash content is close to the theoretical values, and the screen pressure increasing rate is close to that in the normal polyester spinning process. This indicates that there is substantially no loss of TiO₂ nanoparticles due to coagulation during the polymerization and spinning processes. The silane overcoat on the surfaces of the nanoparticles allows the nanoparticles to keep a good dispersed phase until the final product is obtained. Referring to FIG. 1, the flat panel formed from the PET pellets that were blended with the surface-modified TiO₂ of the present invention has an UV transmittance of less than 0.4% in the range of 370˜400 nm (almost no transmission below 370 nm). The UV transmission resulting in the present invention is only 30% of that in the Comparative Example. As such, the inorganic-organic polymeric functional material according to the present invention exhibits an excellent anti-UV function.

In the present invention, the hydrolyzable alkoxysilane compound is added with an alcohol/water solution to form a surface modifier. The hydrolyzation reaction of alkoxysilane can therefore be adjusted and limited so as to prevent formation of a large amount of silanol and self-condensation of a large amount of the silanol. The surface modifier is then used to modify the surfaces of the inorganic oxide nanoparticles so as to form an alkoxysilane overcoat on each of the nanoparticles in order to prevent coagulation of the nanoparticles, thus forming a stable dispersion which permits long-term storage without phase separation and coagulation. The surface-modified nanoparticles can be added into an organic polymer to produce various kinds of inorganic-organic polymeric functional materials. The inorganic oxide nanoparticles modified according to the present invention are particularly suitable for use in producing anti-UV polyester materials with excellent performance. The anti-UV polyester material can be further processed to form fibers, fabrics, films, sheets, and bottles.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method of preparing a surface modifier for nanoparticles, comprising:
hydrolysing 1 part by weight of an alkoxysilane compound with 1˜9 parts by weight of an alcohol/water solution, said alkoxysilane compound being hydrolyzed to form a silanol, wherein the weight ratio of alcohol to water is 60:40˜95:5, and the alcohol/water solution controls the rate of hydrolyzing alkoxysilane so as to limit the rate of forming silanol.

2. The method according to claim 1, wherein the alkoxysilane compound is selected from one of the compounds represented by the following formula (I)-(III): 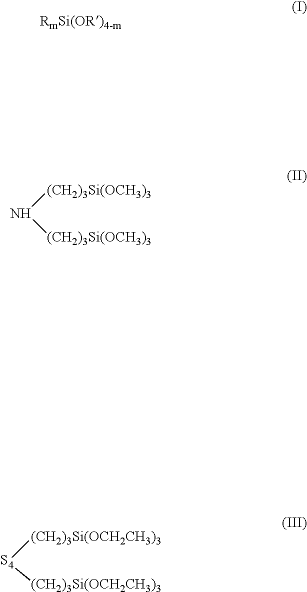
wherein each R is independently selected from the group consisting of alkyl, γ-aminoalkyl, γ-(2,3-glycidoxy)alkyl, β-(3,4-epoxy)-cyclohexyl, γ-methacryloxy-alkyl, vinyl, vinylalkyl, γ-mercaptoalkyl, γ-isocyanato-alkyl, N-phenyl-γ-aminoalkyl, N-β-aminoalkyl-γ-aminoalkyl, and γ-ureidoalkyl, the alkyl contains 1˜10 carbon atoms, each R′ is independently selected from the group consisting of C₁˜C₆ alkyl group, and m is an integer of 1˜2.

3. The method as claimed in claim 2, wherein the alkoxysilane compound is selected from compounds represented by formula (I), where R is γ-2,3-glycidoxyalkyl group, and m is 1.

4. The method as claimed in claim 3, wherein the alkoxysilane compound is γ-(2,3-glycidoxy) propyl-trimethoxysilane.

5. The method as claimed in claim 1, wherein the amount of the alcohol/water solution is 3˜7 parts by weight based on 1 part by weight of the alkoxysilane compound.

6. The method as claimed in claim 5, wherein the alcohol is selected from methanol, ethanol, isopropanol, isobutanol, and combinations thereof.

7. The method as claimed in claim 1, wherein the ratio of the alcohol to water is 70:30˜90:10.

8. The method as claimed in claim 1, wherein the alkoxysilane compound is hydrolyzed at a temperature of 30˜70° C.

9. A surface modifier prepared by a method as claimed in claim 1.

10. A surface modifier prepared by a method as claimed in claim 2.

11. An inorganic oxide dispersion comprising:
100 parts by weight of inorganic oxide nanoparticles;
1˜100 parts by weight of a surface modifier added to the inorganic oxide nanoparticles to modify the surface of the nanoparticles, the surface modifier being prepared by hydrolyzing 1 part by weight of an alkoxysilane in the presence of 1˜9 parts by weight of an alcohol/water solution, wherein the weight ratio of alcohol to water is 60:40˜95:5; and
a dispersing medium.

12. The inorganic oxide dispersion as claimed in claim 11, wherein the inorganic oxide nanoparticles are formed by a material selected from the group consisting of TiO₂, ZnO₂, ZrO₂, Fe₂O₃, NiO, Al₂O₃, SiO₂, Cr₂O₃, 3MgO·4SiO₂.H₂O, silicates, Al₂O₃.SiO₂.XH₂O, FeOOH, and combinations thereof.

13. The inorganic oxide dispersion as claimed in claim 12, wherein the inorganic oxide nanoparticles are formed of TiO₂.

14. The inorganic oxide dispersion as claimed in claim 11, wherein 1˜50 parts by weight of the surface modifier is added to 100 parts by weight of the inorganic oxide nanoparticles.

15. The inorganic oxide dispersion as claimed in claim 11, wherein the dispersing medium is selected from the group consisting of water, monohydric alcohol, dihydric alcohol, and combinations thereof.

16. The inorganic oxide dispersion as claimed in claim 15, wherein the dihydric alcohol is ethylene glycol.

17. An inorganic-organic polymeric functional material, comprising 100 parts by weight of an organic polymer and 0.1˜95 parts by weight of surface-modified inorganic oxide nanoparticles, wherein said surface-modified inorganic oxide nanoparticles comprise 100 parts by weight of inorganic oxide nanoparticles, and 1˜100 parts by weight of a surface modifier added to the inorganic oxide nanoparticles to modify the surface of the nanoparticles, the surface modifier being prepared by hydrolyzing 1 part by weight of an alkoxysilane in the presence of 1˜9 parts by weight of an alcohol/water solution, the weight ratio of alcohol to water in the alcohol/water solution being 60:40˜95:5.

18. The inorganic-organic polymeric functional material as claimed in claim 17, wherein the organic polymer is selected from the group consisting of polyester, polyurethane (PU), polyamide, polyolefin, silicone, epoxy resin, rubber, phenolics, polycarbonate, melamine, polyether, polyvinyl alcohol (PVA), polymethyl methacrylate (PMMA), polystyrene (PS), acrylonitrile-butadiene-styrene (ABS) copolymer, polyvinyl chloride, and combinations thereof.

19. The inorganic-organic polymeric functional material as claimed in claim 17, wherein the amount of said surface-modified inorganic oxide nanoparticles is 0.1 to 30 parts by weight based on 100 parts by weight of the organic polymer.

20. The inorganic-organic polymeric functional material as claimed in claim 17, wherein the inorganic oxide nanoparticles are TiO₂ nanoparticles.

21. The inorganic-organic polymeric functional material as claimed in claim 17, wherein the organic polymer includes a polyester selected from the group consisting of polyethylene terephthalate (PET), copolymers of polyethylene terephthalate (CoPET), polytrimethylene terephthalate (PTT), polybutylene terephthalate (PBT), polylactic acid (PLA), aromatic polyesters, and combinations thereof.

22. An anti-ultraviolet product which comprises an inorganic-organic polymeric functional material as claimed in claim 17.
